(19) United States
(12) Patent Application Publication
(10) Pub. No.: US 2016/0380843 A1
(43) Pub. Date: Dec. 29, 2016

(54) METHOD AND INFORMATION HANDLING SYSTEM PROVIDING AN INTERACTIVE INTERFACE FOR DEVICE-LEVEL MONITORING AND SERVICING OF DATA CENTER

(71) Applicant: DELL PRODUCTS, L.P., ROUND ROCK, TX (US)

(72) Inventors: Tyler B. Duncan, AUSTIN, TX (US); Ty R. Schmitt, ROUND ROCK, TX (US); Anthony P. Middleton, AUSTIN, TX (US); Mark M. Bailey, Round Rock, TX (US)

(21) Appl. No.: 14/748,189

(22) Filed: Jun. 23, 2015

(51) Int. Cl. H04L 12/24; G06F 3/0481; G06F 3/0484

(52) U.S. Cl. CPC H04L 41/22; G06F 3/04842; G06F 3/04815; H04L 41/5061

(57) ABSTRACT

Interactive component-level visual monitoring and controlling an information handling system (IHS) includes displaying a visual representation of one of a plurality of different levels of the IHS based on a current level identified/selected on a graphical user interface (GUI). A current functional state is received of functional components of the IHS at each component level that are being monitored. A controller displays an operating status of at least one functional component on the physical representation at each level of the plurality of different levels. The operating status includes failed, malfunctioning state, and/or a check and/or repair operating state. In response to receiving a user input selecting a specific component level among the one or more levels that is different from a current level being displayed, the controller modifies the GUI to display the physical representation of the specific component level and identifying any components having the problem state.

### RELATED APPLICATIONS

The present application is related to the following copending U.S. patent applications Ser. No. ______ (Docket No. 105199.01); Ser. No. ______ (Docket No. 105212.01); and Ser. No. ______ (Docket No. 105213.01), all filed concurrently herewith, with relevant content of each related application being incorporated herein by reference.

### BACKGROUND

1. Technical Field

The present disclosure relates in general to enterprise-level monitoring and diagnostic systems, and more particularly to graphical user interface (GUI) control of large-scale information handling systems (LIHS).

2. Description of the Related Art

As the value and use of information continue to increase, individuals and businesses seek additional ways to process and store information. One option available to users is information handling systems (IHSes). An IHS generally processes, compiles, stores, and/or communicates information or data for business, personal, or other purposes, thereby allowing users to take advantage of the value of the information. Because technology and information handling needs and requirements vary between different users or applications, IHSes may also vary regarding what information is handled, how the information is handled, how much information is processed, stored, or communicated, and how quickly and efficiently the information may be processed, stored, or communicated. The variations in IHSes allow for IHSes to be general or configured for a specific user or specific use such as financial transaction processing, airline reservations, enterprise data storage, or global communications. In addition, IHSes may include a variety of hardware and software components that may be configured to process, store, and communicate information and may include one or more computer systems, data storage systems, and networking systems.

Conventional modular data centers (MDCs) and server systems provide discrete monitoring and control systems that do not interface with each other. Whenever a failure, error, or issue is encountered in the MDC and server system that requires evaluation and potential correction, the general nature of the error or failure is identified and passed to a service technician or team. The service technician or team is dispatched to the location of the MDC or server system in which the failure or error was detected. The technician or team has to spend significant time identifying the source of the failure, error, or issue as well as trouble shooting on site to determine what possible solutions exist. This process is time consuming and costly.

### BRIEF SUMMARY

In accordance with the teachings of the present disclosure, an information handling system (IHS) includes a node having at least one functional component, wherein the node and the at least one functional component are capable of being in more than one functional state. The IHS includes a network interface enabling communication with a network over which the node is connected. The IHS includes a memory containing visual representations of the node with a plurality of different levels of visual representations, including a system level, node levels, sub-node levels, and component levels. The IHS includes a display device that provides a graphical user interface (GUI) on which each of the different levels of visual representations can be presented. At least one user input component is capable of manipulating and/or interfacing with one or more items on the graphical user interface (GUI). An interactive component-level visual monitoring and control (ICVMC) system includes a processor in communication with the display device, the memory, and the network interface. ICVMC program modules executes on the processor and configures the ICVMC system to (a) display on the display device the visual representation of one of the plurality of different levels of the IHS based on a current level identified/selected on the GUI; (b) receive, via the network interface, a current functional state of functional components at each component level that is being monitored; (c) determine an operating status of the at least one functional component from the current functional state received; (d) display on the display device the operating status of the at least one functional component on the physical representation at each level of the plurality of different levels when the operating status includes a problem state from among a failed operating state, a malfunctioning state, and/or a check and/or repair (C/R) operating state; and (e) in response to receiving a user input, select a specific component level among the one or more levels that is different from a current level being displayed, modify the GUI to display the physical representation of the specific component level, and identify, within the GUI, any components having the problem state.

In accordance with embodiments of the present disclosure, an ICVMC system of an IHS includes a network interface enabling communication with a network over which a node is connected, the node of the IHS having at least one functional component. The node and the at least one functional component are capable of being in more than one functional state. A memory contains physical representations of the plurality of nodes with a plurality of different levels of visual representations, including a system level, node levels, sub-node levels, and component levels. A display device provides a GUI upon which each of the different levels of visual representations can be presented. At least one user input component is capable of manipulating and/or interfacing with one or more items on the graphical user interface. A controller includes a processor in communication with the display device, the memory, and the network interface. ICVMC program modules executes on the processor and configures the ICVMC system to: (a) display on the display device the visual representation of one of the plurality of different levels of the IHS based on a current level identified/selected on the GUI; (b) receive, via the network interface, a current functional state of functional components at each component level that is being monitored; (c) determine an operating status of the at least one functional component from the current functional state received; (d) display on the display device the operating status of the at least one functional component on the physical representation at each level of the plurality of different levels when the operating status includes a problem state from among a failed operating state, a malfunctioning state, and/or a C/R operating state; and (e) in response to receiving a user input selecting a specific component level among the one or more levels that is different from a current level being displayed, modify the GUI to display the physical representation of the specific component level and identify, within the GUI, any components having the problem state.

According to illustrative embodiments of the present disclosure, a method is provided of interactive component-level visual monitoring and controlling an IHS. In one or more embodiments, the method includes displaying on a display device a visual representation of one of a plurality of different levels of the IHS based on a current level identified/selected on a GUI. The method includes receiving, via a network interface, a current functional state of functional components of the IHS at each component level that is being monitored. The method includes determining an operating status of at least one functional component from the current functional state received. The method includes displaying on the display device the operating status of the at least one functional component on the physical representation at each level of the plurality of different levels when the operating status includes a problem state from among a failed operating state, a malfunctioning state, and/or a C/R operating state. The method includes, in response to receiving a user input selecting a specific component level among the one or more levels that is different from a current level being displayed, modifying the GUI to display the physical representation of the specific component level and identifying, within the GUI, any components having the problem state.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a block diagram representation of an example information handling system (IHS) having an Interactive Component-Level Visual Monitoring and Control (ICVMC) System, according to one or more embodiments;

FIG. 2 illustrates an example Large-Scale Information Handling System (LIHS) having a server system that is monitored and controlled by a control center implementing an ICVMC system, according to one or more embodiments;

FIG. 3 illustrates an LIHS in which a controller of the ICVMC system executes an LIHS Graphical User Interface (GUI) program module to display a status indication of a problem state, according to one or more embodiments;

FIG. 4 illustrates a multi-tiered LIHS with an ICVMC system including a controller to monitor and control nodes and a sub-node using a multi-tier GUI, according to one or more embodiments;

FIG. 5 illustrates an upper-level GUI with location annotations on a geographic map, according to one or more embodiments;

FIG. 6 illustrates the upper-level GUI of FIG. 5 with a change in the scale of the geographic map, according to one or more embodiments;

FIG. 7 illustrates a large-scale system level GUI with color or pattern overlays depicting operating or problem status, according to one or more embodiments;

FIG. 8 illustrates a system level GUI with color or pattern overlays depicting operating or problem status, according to one or more embodiments;

FIG. 9 illustrates a subsystem level GUI with color or pattern overlays for operating or problem status, according to one or more embodiments;

FIG. 10 illustrates an example component level GUI with color or pattern overlays depicting operating or problem status, according to one or more embodiments;

FIG. 11 illustrates an additional example subsystem level GUI with color or pattern overlays depiciting operating or problem status, according to one or more embodiments;

FIG. 12 illustrates a diagram of multi-tier GUIs depicting a failure indication, according to one or more embodiments; and

FIGS. 13A-13B illustrate a method of interactive component-level visual monitoring and controlling an IHS, according to one or more embodiments.

### DETAILED DESCRIPTION

Interactive component-level visual monitoring and controlling an information handling system (IHS) includes displaying a visual representation of one of a plurality of different levels of the IHS based on a current level identified/selected on a graphical user interface (GUI). A current functional state is received of functional components of the IHS at each component level that is being monitored. A controller displays an operating status of at least one functional component on the physical representation at each level of the plurality of different levels. The different operating status can include a failed state, malfunctioning state, and/or a check and/or repair operating state. In response to receiving a user input selecting a specific component level among the one or more levels that is different from a current level being displayed, the controller modifies the GUI to display the physical representation of the specific component level and identifies, within the GUI, any components having the problem state.

The present innovations provide an Interactive “Component-Level” Visual Monitoring and Control (ICVMC) Module/System for a server system, and with particular application for a server system that is a large-scale IHS (LIHS). In an exemplary embodiment of LIHSes, ICVMC can provide monitoring and diagnostic services for a large-scale modular information handling system (LMIHS) that is a particular type of LIHS based on modular data centers (MDCs) that are networked and centrally managed. In one aspect, ICVMC maps a series of graphical user interfaces (GUIs) linked to different levels and sub-levels of a layout and configuration of hardware devices and firmware components of an information handling system (IHS) such an MDC or LMIHS. The top-level GUI provides a rendering of the general overview of an entire enterprise IHS. From this level, a user is able to drill down to various sub-levels of GUIs representing different parts of device topology. The user can drill down all the way to a device/component level via a series of interactive clicks, touch screen selections, and/or menu selections. Each GUI can present a visual image of physical components at that level or sub-level of the IHS to which the user has drilled down to.

In one or more embodiments, feedback is received from monitors and sensors placed at, within or adjacent to various locations (and/or specific components or devices) within the IHS. That feedback is then utilized by the program to update the particular GUI providing the visual representation of the component or device. When a failure or monitored condition is detected at the device, a corresponding signal is transferred back to the ICVMC. In some instances a corrective or mitigating action is automatically taken or triggered. In other instances, the location of the failure or event is highlighted at each GUI level at and above the location of the monitored device. Using this graphically displayed information, the user can identify corrective measures required, including providing firmware updates and component resets, etc., without having to dispatch a technician or technician team. When a technician or technician team is required, the exact device that has failed or triggered the condition and the device's location within the overall IHS as well as specific information on the required fixes, etc., can be sent to the technician or technician team as a troubleshooting ticket. This ticket can be created by the ICVMC and delivered electronically (e.g., via email) in one embodiment. Faster and more efficient and effective resolution and fixes are implemented whether automated or via a technician.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different elements, features, protocols, or concept names are utilized. Thus, each term utilized herein is to be given its broadest interpretation given the context in which that terms is utilized.

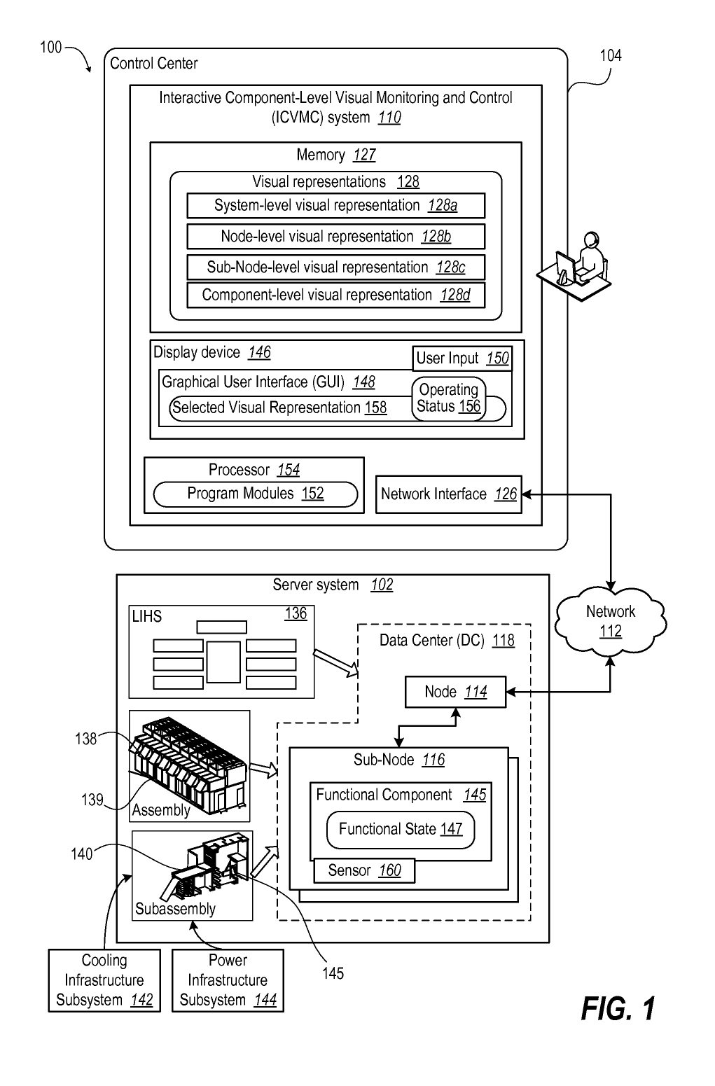

FIG. 1 illustrates a block diagram representation of an example information handling system (IHS) 100. In at least one embodiment, because of the relatively large architectural scale of an enterprise IHS of multiple standalone MDCs and MDCs arranged in a high availability (HA) arrangement as a large-scale information handling system (LIHS) or simply an IHS. Within the general context of IHSes, an information handling system (IHS) 100 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network storage device, or any other suitable device and may vary in size, shape, performance, functionality, and price. The IHS may include memory, one or more processing resources such as a central processing unit (CPU) or hardware or software control logic. Additional components or the IHS may include one or more storage devices, one or more communications ports for communicating with external devices, as well as various input and output (I/O) devices, such as a keyboard, a mouse, and a video display. The IHS may also include one or more buses operable to transmit communication between the various hardware components. It is appreciated that the IHS described within the present disclosure is a LIHS, with servers acting as the individual processing units.

In one or more embodiments, the IHS 100 can include a server system 102 that is to be interactively monitored at a component level from a control center 104, which can be co-located with or remote to the server system 102. The server system 102 can be one or more rack-mounted servers, a data center (DC) that contains rack-mounted servers, one or more modular data centers (MDCs), or one or more LIHSes. For clarity, an Interactive Component-Level Visual Monitoring and Control (ICVMC) system 110 at the control center 104 communicates over a network 112 with a node 114 and in turn with one or more sub-nodes 116 of a DC 118. The ICVMC system 110 includes a network interface 126 enabling communication with the network 112 over which the node 114 is connected. In one or more embodiments, the network interface 126 can communicate with a local network. In one or more embodiments, the network interface 126 can communicate over a wide area network to geographically dispersed portions of a DC 118.

The ICVMC system 110 includes a memory 127 containing visual representations 128 of the plurality of nodes with a plurality of different levels of visual representations 128, including a system level, node levels, sub-node levels, and component levels. The system level, node levels, sub-node levels, and component levels 128a-128d can be physical representations. For example, a system level visual representation 128a can be an external rendering of three-dimensional computer aided design (CAD) model or photograph of an LIHS 136 that includes more than one MDC 138. A node level visual representation 128b can be an isometric rendering of a CAD model or photograph of an assembly 139, such as one MDC 138. A sub-node level visual representation 128c can be an isometric rendering of a CAD model or photograph of a subassembly 140 of one MDC 138, such as a cooling or power infrastructure environmental subsystem 142, 144. Node level visual representations 128b and/or sub-node level visual representations 128c can include an isometric rendering of a CAD model or photograph of one or more functional components 145. Additional hierarchical representations can be included down to sub-subassemblies, etc. For clarity, some levels of visual representation can include, or entail entirely, a functional representation such as for sensor and electrical power that do not lend themselves readily to an isometric view.

The ICVMC system 110 can include a display device 146 that provides a graphical user interface (GUI) 148 on which each of the different levels of visual representations 128a-128d can be presented. The ICVMC system 110 can include at least one user input component 150 that is capable of manipulating and/or interfacing with one or more items on the GUI 148.

The ICVMC system 110 can execute ICVMC program modules 152 on a processor 154 in communication with the display device 146, the memory 127, and the network interface 126 to configure the ICVMC system 110 to display on the display device 146 the visual representation 128 of one of the plurality of different system, node subnode levels (e.g., LIHS 136, MDC 138, cooling or power infrastructure environmental subsystem 142, 144) of the IHS 100 based on a current level identified/selected on the GUI 148. The ICVMC system 110 can receive, via the network interface 126, a current functional state 147 of functional components 145 at each component level that is being monitored by one or more sensors 160. The ICVMC system 110 can determine an operating status 156 of the at least one functional component 145 from the current functional state 147 received with reference to maintenance information 115 that is indexed specifically to the particular functional component 145, subnode 116 and node 114 and that is stored in memory 127. The ICVMC system 110 can display on the display device 146 the operating status 156 of the at least one functional component 145 on a selected visual representation 158 at each level of the plurality of different levels when the operating status 156 includes a problem state from among a failed operating state, a malfunctioning state, and/or a check and/or repair (C/R) operating state. For example, a failed operating state can indicate a functional component 145 that is entirely nonfunctional, i.e., has stopped working. A malfunctioning operating state can indicate a functional component 145 that intermittently is nonfunctional. A C/R operating state can be a functional component 145 that is performing its function satisfactorily but is sensed as having an increased likelihood of failure. For example, the service count is high, a sensor reading is out of a normal operating range, such as for power consumed or temperature, etc. The ICVMC system 110 can, in response to receiving a user input selecting a specific component level among the one or more levels that is different from a current level being displayed, modify the GUI 148 to display the visual representation 128a-128d of the specific component level selected and identify any components having the problem state.

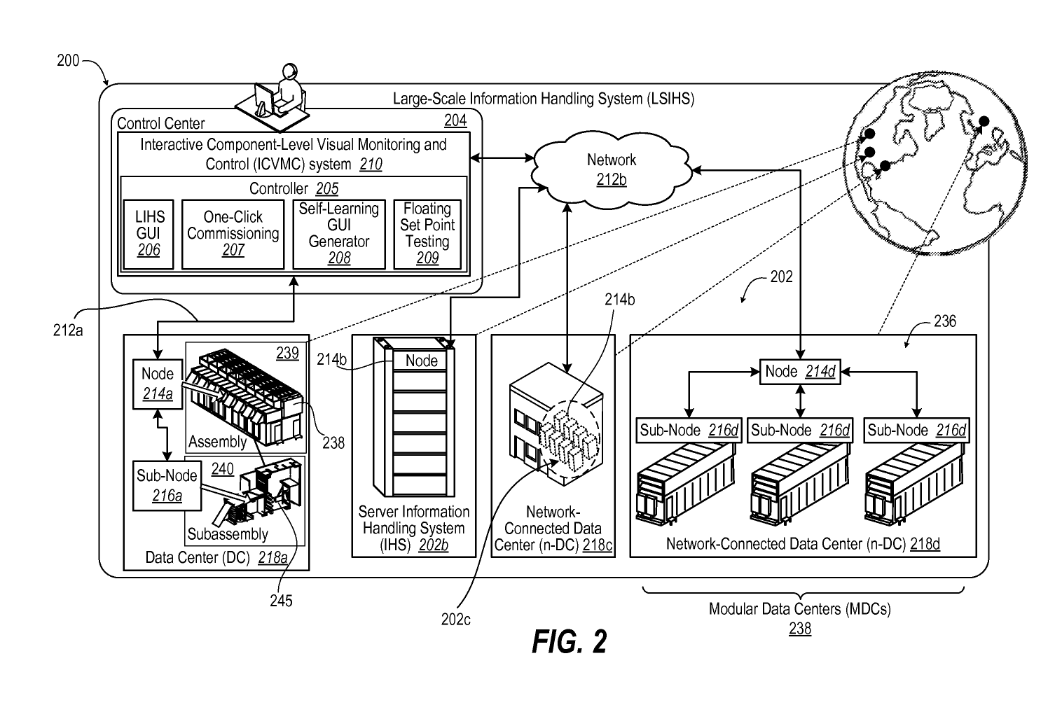

FIG. 2 illustrates an example LIHS 200 having server systems 202 that are monitored and controlled via a control center 204 by using an ICVMC system 210 having a controller 205 that executes ICVMC program modules. In an exemplary embodiment, the controller 205 executes an LIHS GUI program module 206, a one-click commissioning program module 207, a self-learning GUI generator program module 208, and a floating set point testing program module 209. In one or more embodiments, the ICVMC system 210 manages a node 214a and sub-nodes 216a via a local network 218a of a local DC 218a. For example, the local DC 218a can be an MDC 238 that includes assemblies 239 and subassemblies 240 containing functional components 245. In one or more embodiments, the ICVMC system 210 manages a node 214b of rack-mounted server system 202b over a geographically distributed network 212b. In one or more embodiments, the ICVMC system 210 manages a node 214c of a network-connected data center (nDC) 218c having rack-mounted server systems 202c located over the geographically distributed network 212b. In one or more embodiments, the ICVMC system 210 manages, over the geographically distributed network 212b, a node 214d of a network-connected data center (nDC) 218d that includes an LIHS 236 having sub-nodes 216d of MDCs 238.

In an exemplary embodiment, the ICVMC system 210 can perform one or more interactive control functions by monitoring systems to detect opportunities for intervention. Certain functions are automated and others facilitate control by a human operator. For example, LIHS GUI program module 206 can intuitively utilize CAD models that have problem areas illuminated with semi-transparent overlays. The operator can select areas, such as by touching a touch screen, to drill down in the GUI 148 to a next deeper level view. The GUI 148 can be provisioned with and/or identify all functional components 245 and sensors as well as visually indicate their geographic or relative physical location on CAD models or other physical renderings. In addition to drilling down to component-level visual information, the ICVMC system 210 can facilitate as a unified tool moving to upper levels to quickly visualize an operational layout and operating status of a data center or LIHS. The ICVMC system 210 can push control code to functional components for correcting a malfunction or to perform diagnostic testing.

The one-click commissioning program module 207 of the ICVMC system 210 can provide a single button to push updates or customizations to global data centers. The one-click commissioning program module 207 can provide an automated procedure to test all devices on a module and report the results of each test. The self-learning GUI generator program module 208 of the ICVMC system 210 can change between left and right modules in a setup of an MDC 138 or an LIHS 200. The self-learning GUI generator program module 208 of the ICVMC system 210 can auto-detect device configuration.

The floating set point testing program module 209 of the ICVMC system 210 can have common control code while utilizing a separate configuration file to set customer/site specific set points for customized operation. The floating set point testing program module 209 can push control code to functional components to perform diagnostic testing and can retrieve diagnostic information, such as programmable logic controller (PLC) logs. The ICVMC system 210 can also perform testing of a communication system across the LIHS 200 by decoupling control code from communication outputs. For example, a single button control can set unique values to all analog registers to prove true one-to-one correspondence. For another example, automatic cycling through all registers can be performed at a user-defined speed to test that all binary registers are received by third-party software. The floating set point testing program module 209 can use persistent variables for all set points, which are modifiable by commissioning and administer user levels. The floating set point testing program module 209 can return all set points to factory defaults after commissioning user level is completed. The floating set point testing program module 209 can enable floating set points to optimize power while controlling temperature and humidity for specific portions of the LIHS 200.

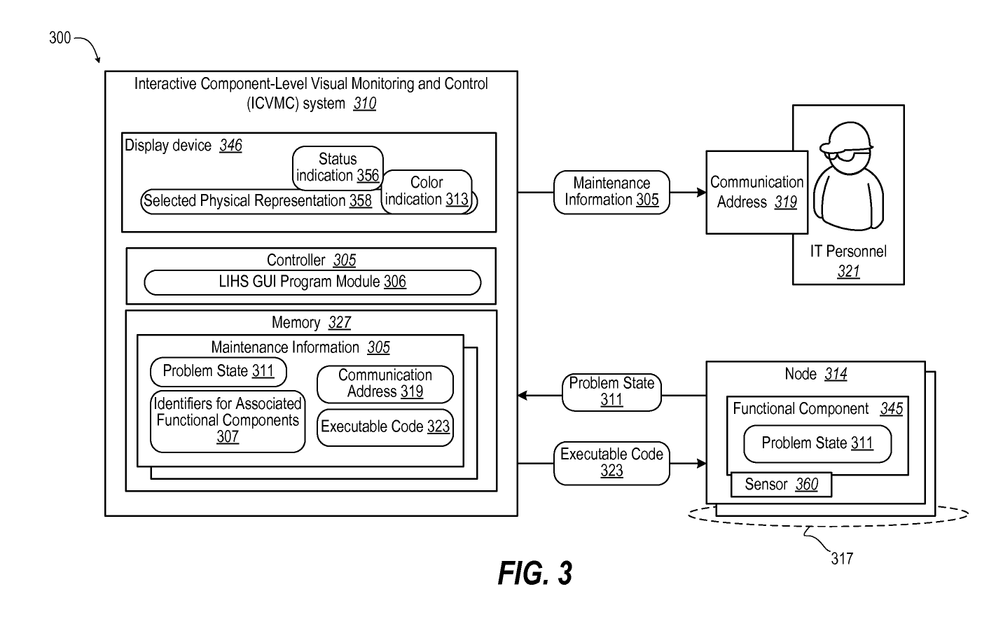

FIG. 3 illustrates an LIHS 300 in which a controller 305 of an ICVMC system 310 executes an LIHS GUI program module 306 to display a status indication 356 of a problem state 311 reported by a sensor 360. In a particular embodiment, the status indication 356 is displayed on a display device 346 by overlaying a color indication 313 at a corresponding component location on a physical representation 358 of each higher level visual/graphical/schematic depiction displayed on the display device 346. The controller 305 accesses a memory 327 that contains maintenance information 315 corresponding to each of a plurality of different problem states 311 of different functional components 345. The controller 305 associates maintenance information 315 with the problem state 311 and identifiers 307 for associated functional components 345. For example, the problem state 311 and maintenance information 315 may be specific to a particular model number, firmware version, serial number range, and/or original equipment manufacturer (OEM). The controller 305 can direct a maintenance action to correct the problem state 311 identified for a specific functional component 345.

In one or more embodiments, the maintenance information 315 includes a location 317 of the functional component 345 and a communication address 319 of information technology (IT) personnel device 321 that are assigned to fix the problem states 311 of the specific functional component at the specific location of the component. The ICVMC system 310 transmits the maintenance information 315 to the communication address 319 of the IT personnel device 321 assigned to fix the problem state 311 of the specific functional component 345.

In one or more embodiments, the maintenance information 315 includes executable code 323 for correcting the problem state 311 of the functional component 345. The executable code 323 can be one or more of a malfunction mitigating mode of operation for the component and an upgrade firmware for execution by the functional component 345. The controller 305 directs the executable code 323 to be installed on the functional component 345 via a corresponding node 314 in response to the problem state 311.

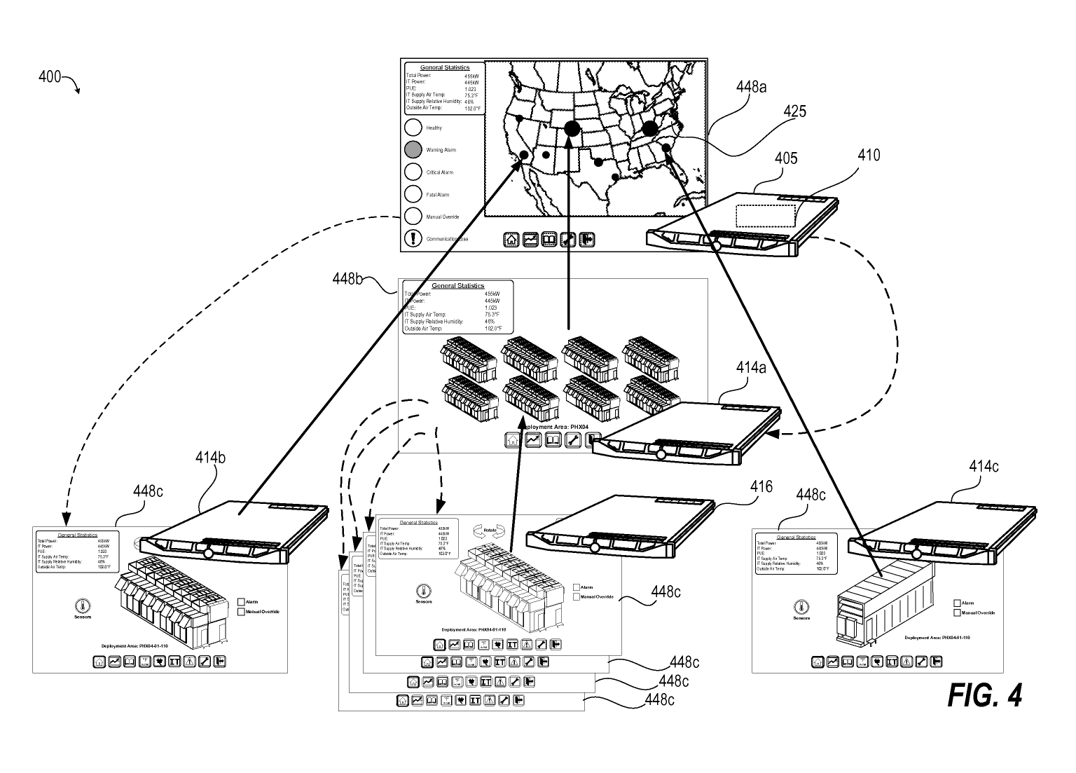

FIG. 4 illustrates an LIHS 400 that is multi-tier with an ICVMC system 410, which includes a controller 405 to monitor and control nodes 414a-414c and a sub-node 416 using a multi-tier GUI 448. The GUIs can be multi-tier by presenting the LIHS 400 in different levels of detail and granularity. A fault at a particular geographic location can be presented in an upper level view. A user can drill down through tiers or levels in a hierarchy of GUIs to follow the fault to one or more contributing functional components or subsystem of functional components. In one or more embodiments, an upper level GUI 448a can depict a geographical view 425 with locations and operating status of server systems annotated. A user input to a location can link to a large-scale system level GUI 448b, which can include a data center layout of multiple MDCs. A user input to a particular MDC on the large-scale system level GUI 448b can link to one of more than one system-level GUI 448c. Other locations on the upper-level GUI 448a can link directly to a system-level GUI 448c for smaller data centers. The levels can also be referred to as nodes and sub-nodes. Additional levels of GUIs can be provided in other implemetations, and the presentation herein of a specific subset of GUIs is not intented to limit or be viewed as a limaition on the actual numbers of levels utilized and/or available to be accessed and displayed.

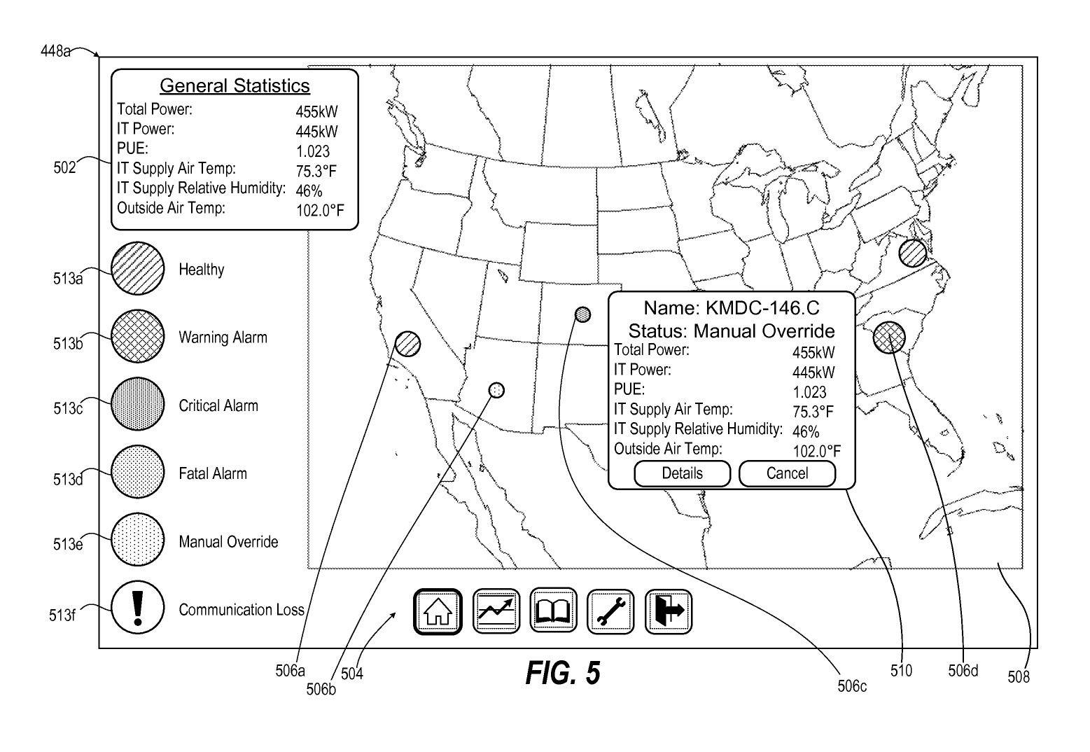

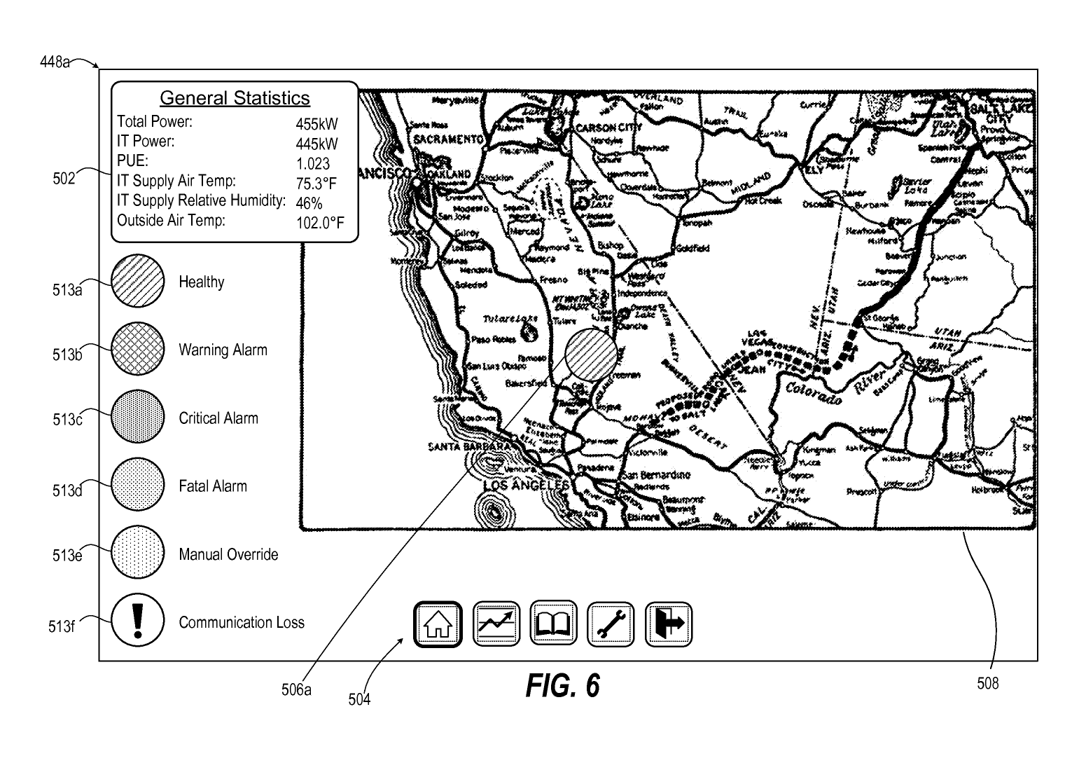

FIG. 5 illustrates the upper-level GUI 448a with high level statistic legend 502, control keys 504, and location annotations 506a-506d on a geographic map 508. This upper level GUI 448a can provide physical aspects of the city, highways, power infrastructures, with minimal details of each portion of the LIHS 400. The location annotations 506a-506d are colored or patterned according to their respective operating status as specified in color status indications 513a-513f respectively for healthy, warning alarm, critical alarm, fatal alarm, manual override, and communication loss. A location status legend 510 is selected to provide more information about the operating status. FIG. 6 illustrates the upper-level GUI 448a with a change in the scale of the map 508. The map 508 can be geographically accurate, drawn to equally space each location regardless of the actual distance between locations, or drawn with other orientations. In one or more embodiments, the LIHS 400 can be at a single location and thus obviating the need for a map 508.

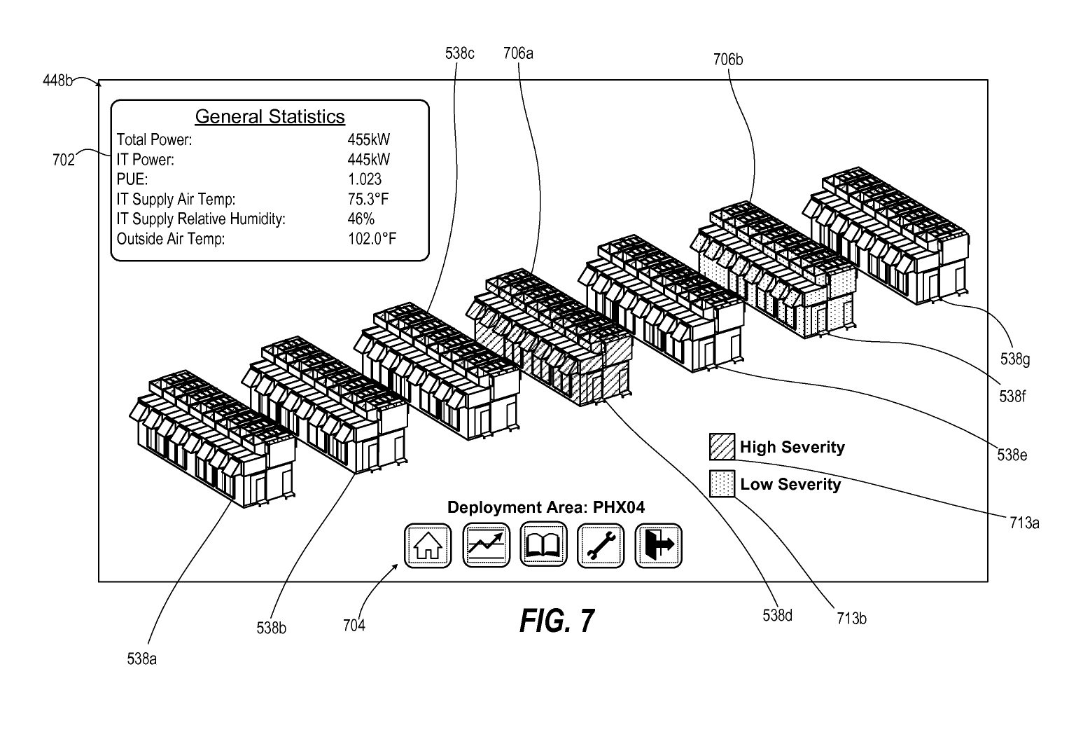

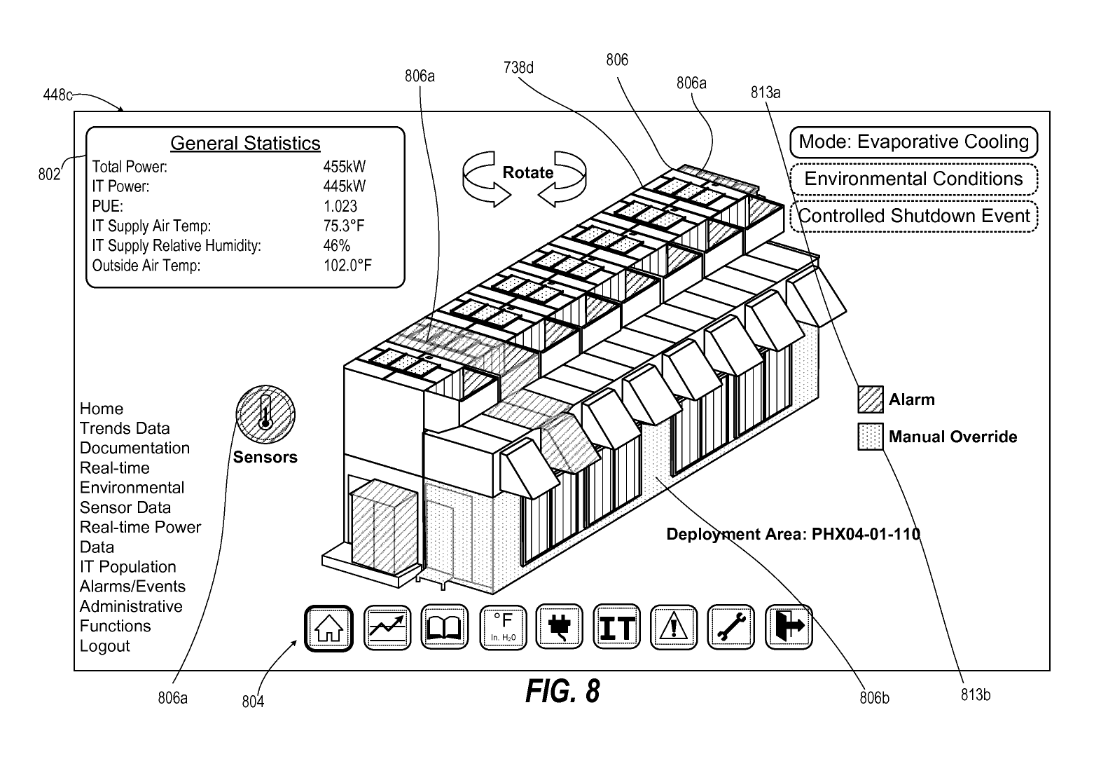

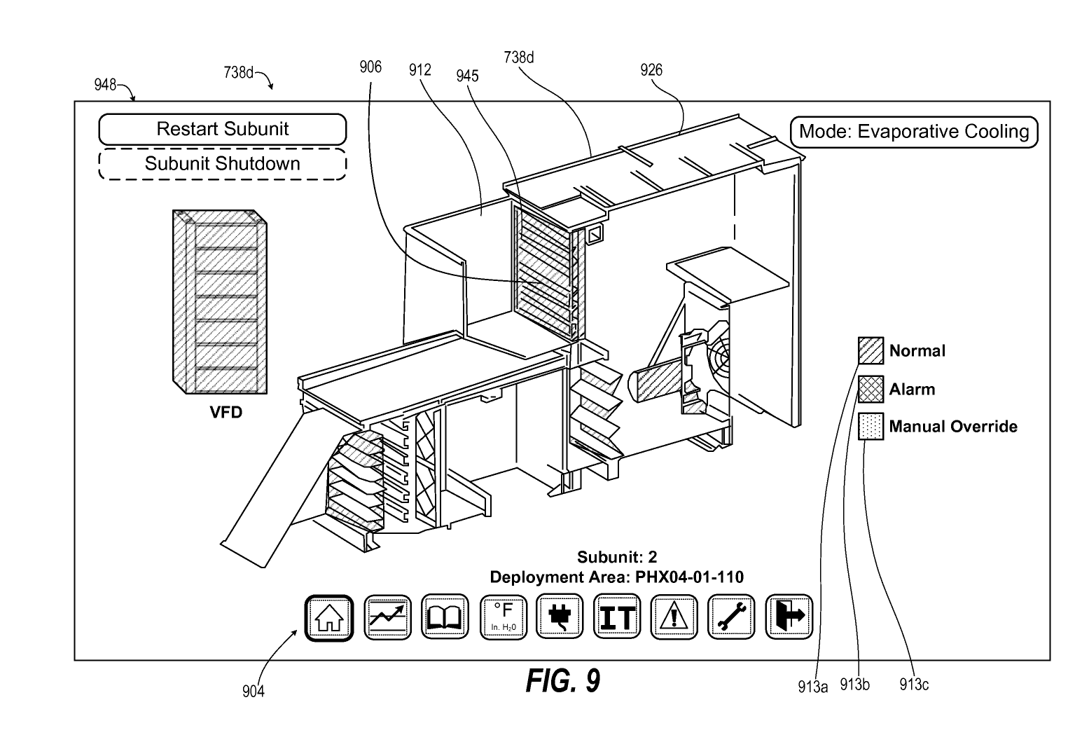

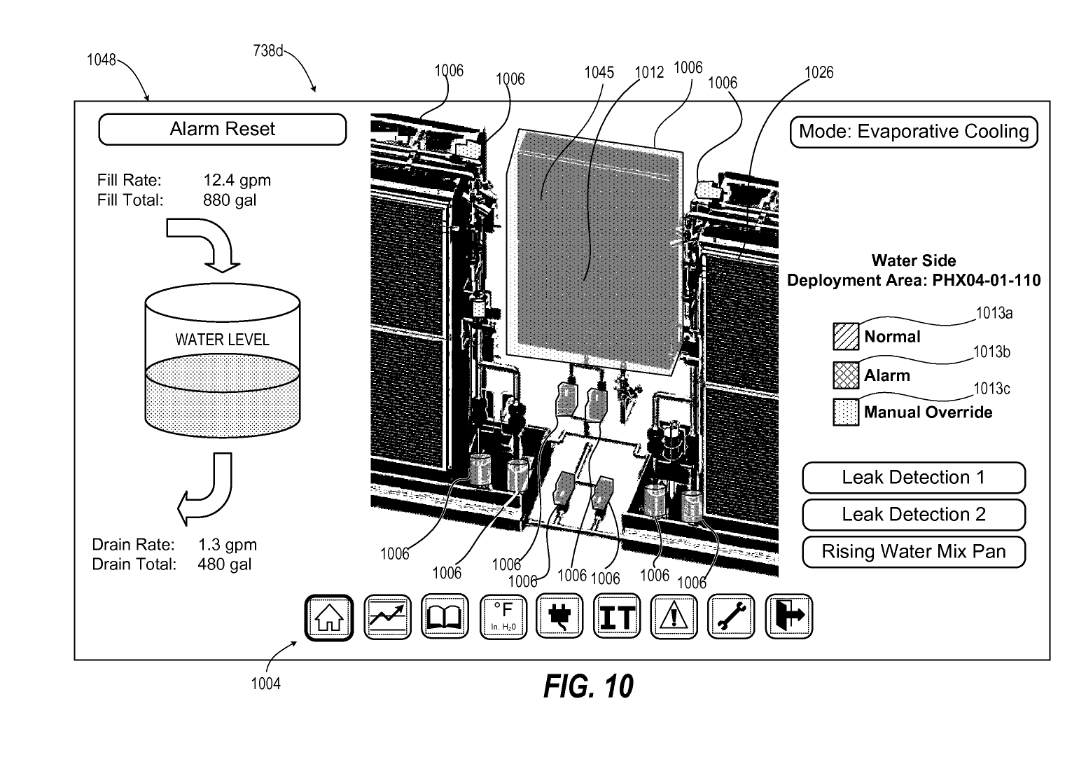

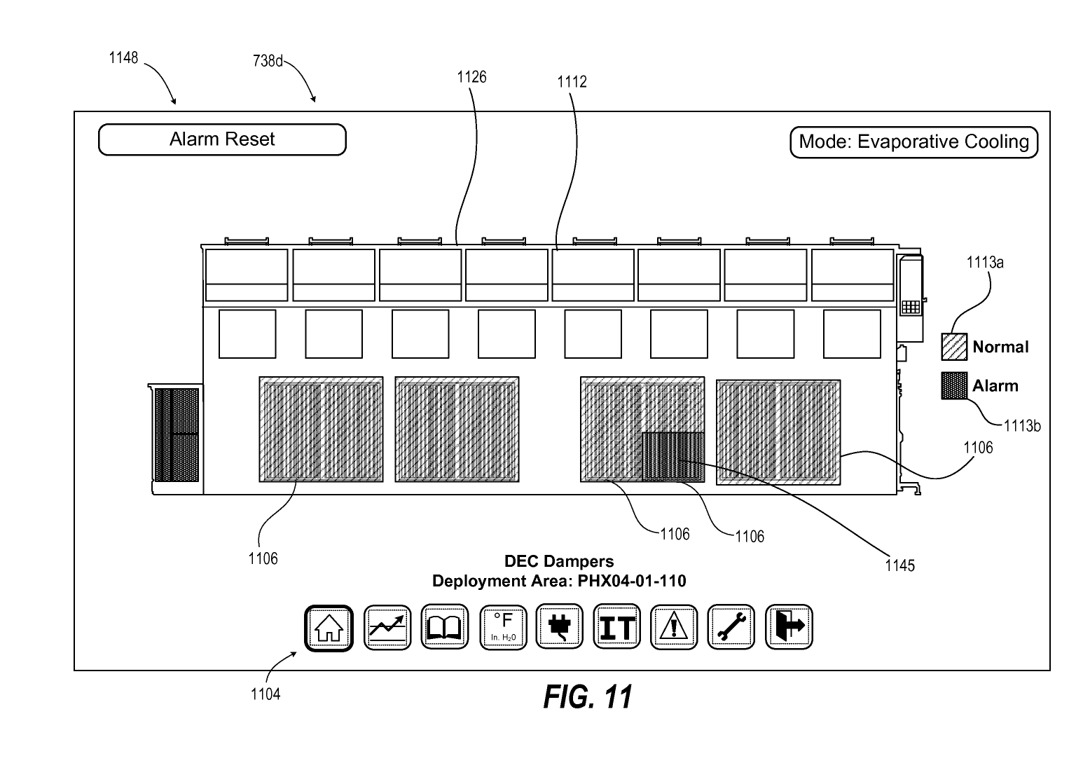

FIG. 7 illustrates the large-scale system level GUI 448b with high level statistic legend 702, control keys 704, and MDCs 738a-738g. MDC 738d has a color or pattern overlay 713a for high severity and MDC 738f has a color or pattern overlay 713b for low severity. Within the described embodiments, severity can indicate a level of degradation of performance of particular portion of the LIHS 400. Alternatively or in conjunction, severity can indicate a level of urgency of performing repairs. Severity can also indicate a level of risk to damage to the LIHS 400. The level of severity can be identified with specific color coding at the particular location of the component that is experiencing or exhibiting a problem state (e.g., failure condition provides a red color overlay of the component location). FIG. 8 illustrates a system level GUI 448c with high level statistic legend 802, control keys 804, and a physical presentation 806 of the MDC 738d with color or pattern overlays for grapical status indications 806a for textual status indication 813a and color or pattern overlay 806b for an operating status of manual override 813b. FIG. 9 illustrates a subsystem level GUI 948 with control keys 904, and a physical presentation 926 of a subassembly 912 of MDC 738d with color or pattern overlays for grapical status indications 906 that are explained to correspond for an operating status for functional components 945 respectively of a normal status indication 913a, an alarm status indication 913b and a manual override status indication 913c. FIG. 10 illustrates an example component level GUI 1048 with control keys 1004, and a physical presentation 1026 of a subassembly 1012 of MDC 738d with color or pattern overlays 1006 respectively for an operating status for functional components 1045 respectively of a normal status indication 1013a, an alarm status indication 1013b and a manual override status indication 1013c. FIG. 11 illustrates a subsystem level GUI 1148 with control keys 1104, and a physical presentation 1126 of a subassembly 1112 of MDC 738d with color or pattern overlays 1106 respectively for an operating status for functional components 1145 respectively of normal 1113a and alarm 1113b.

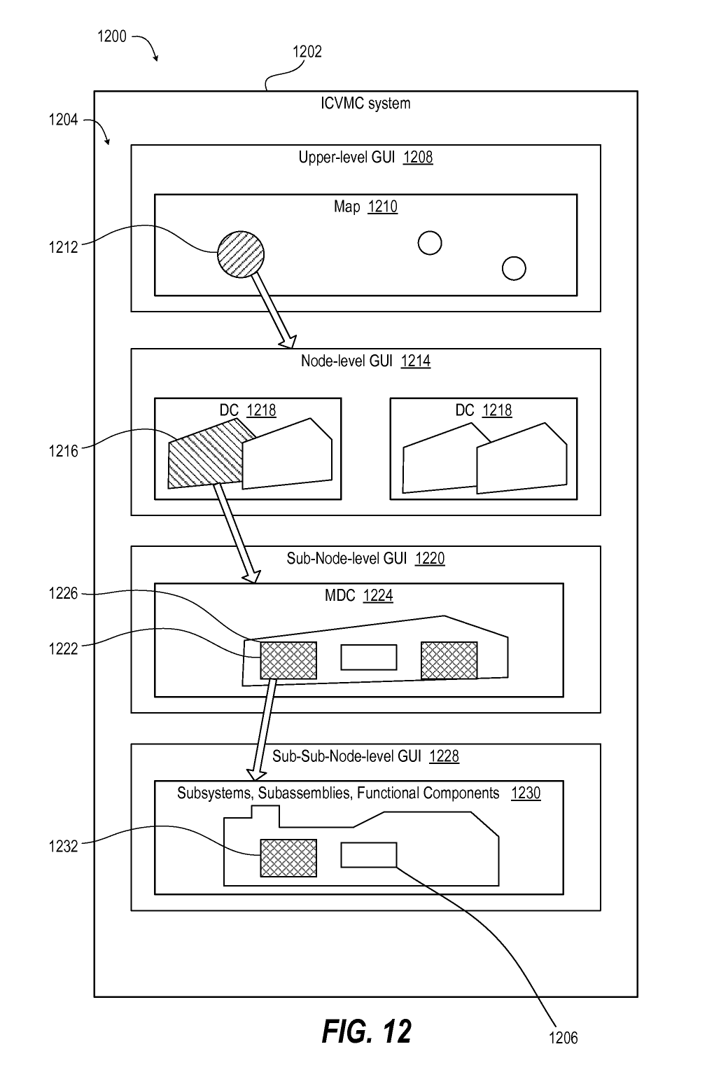

FIG. 12 illustrates an LIHS 1200 having a ICVMC system 1202 that depicts multi-tier GUIs 1204 that enable a user to investigate degraded operating states and failures of functional components 1206. An upper level GUI 1208 can depict geographically displaced portions of the LIHS 1200 on a map 1210. One location indication 1212 can have color, pattern or size, etc. that alerts a user of a status that warrants further investigation. For example, a portion of the LIHS 1200 can indicate requiring maintenance although a severity can be relatively low due to sufficient redundancy at the location to handle the work load. Selecting the location indication 1212 within the upper level GUI 1208 can direct a user to a node-level GUI 1214 with a status indication 1216 for a particular data center 1218 that is operating at a degraded level due to a failure condition. The user can select the particular data center 1218 to further investigate the failure condition, which selection links to a sub-node GUI 1220 that depicts a particular MDC 1224. Portions 1222 of the MDC 1224 can be annotated with a failure indication 1226. Further investigation can be facilitated by selecting a failed portion 1222 to interact with a lower Sub sub-node level GUI 1228 such as depicting subsystems, subassemblies, functional components, 1230, etc., that have failure indication 1232. The severity of the indication at each level of the multi-tier GUIs 1204 can change with greater granularity of a portion of the LIHS 1200. At a top level, a particular failure may have no discernible impact to performance of the entire LIHS 1200. At the lowest levels of the multi-tier GUIs 1204 a failure can have the highest severity with regard to the operability of an affected subsystem or system.

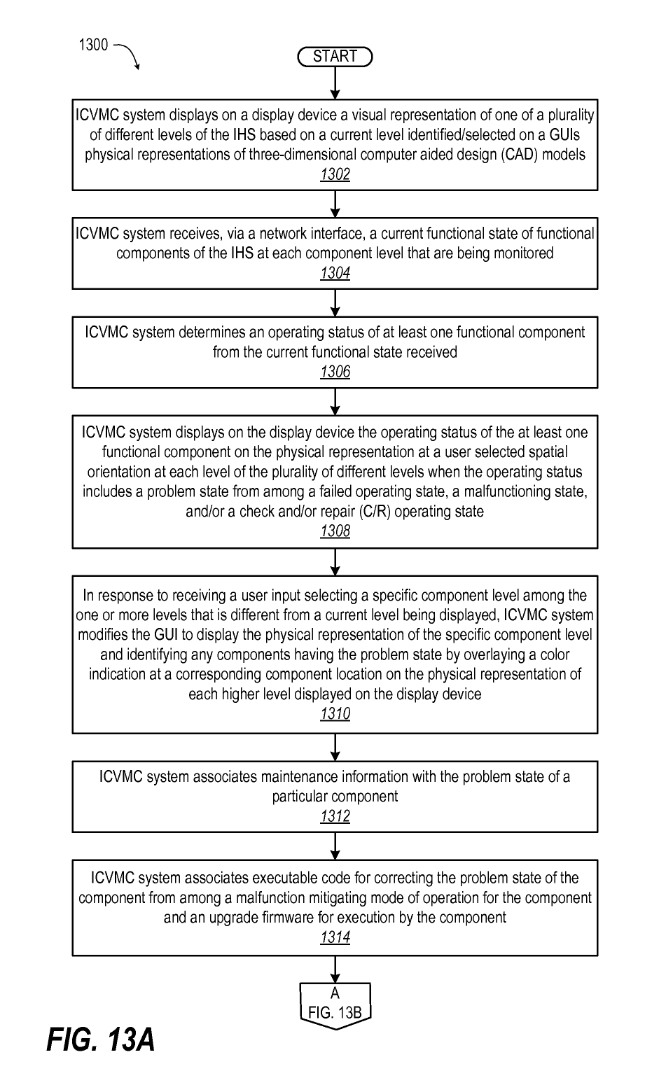

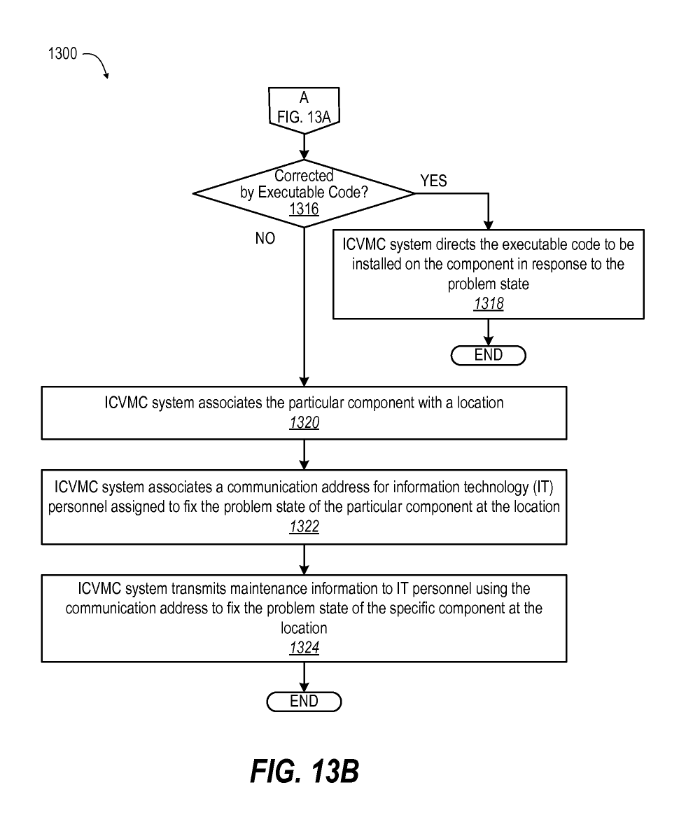

FIGS. 13A-13B illustrate a method 1300 of interactive component-level visual monitoring and controlling an IHS. In an exemplary embodiment, the IHS comprises a modular data center that contains server systems and comprises one of an infrastructure environmental subsystem and an infrastructure power subsystem that includes the at least one functional component. In one or more embodiments, the method 1300 includes an ICVMC system displaying on a display device a visual representation of one of a plurality of different levels of the IHS based on a current level identified/selected on a GUI. In one or more embodiments, the displaying of physical representations comprises rendering three-dimensional computer aided design (CAD) models (block 1302). The method 1300 includes the ICVMC system receiving, via a network interface, a current functional state of functional components of the IHS at each component level that is being monitored (block 1304). The method 1300 includes the ICVMC system determining an operating status of at least one functional component from the current functional state received (block 1306). The method 1300 includes the ICVMC system displaying on the display device the operating status of the at least one functional component on the physical representation at a user-selected spatial orientation, where the operating status is dislayed at each level of the plurality of different levels when the operating status includes a problem state from among a failed operating state, a malfunctioning state, and/or a check and/or repair (C/R) operating state (block 1308). The method 1300 includes the ICVMC system, in response to receiving a user input selecting a specific component level among the one or more levels that is different from a current level being displayed, modifying the GUI to display the physical representation of the specific component level and identifying, within the GUI, any components having the problem state.

In one or more embodiments, the method 1300 includes the ICVMC system displaying the status indication of the problem state on the display device by overlaying a color indication at a corresponding component location on each higher level physical representation displayed on the display device (block 1310). The method 1300 includes the ICVMC system associating maintenance information with the problem state of a particular component (block 1312). A determination is made as to whether the problem state can be corrected by directing executable code to be installed on the component (decision block 1314). In response to determining that the problem state can be corrected by directing executable code to be installed on the component, the method 1300 includes the ICVMC system associating executable code for correcting the problem state of the component, where the executable code can be from among a malfunction mitigating mode of operation for the component and an upgrade firmware for execution by the component (block 1316). The method 1300 includes the ICVMC system directing the executable code to be installed on the component in response to the problem state (block 1318). Then method 1300 ends.

In response to determining that the problem state cannot be corrected by directing executable code to be installed on the component in decision block 1314, the method 1300 includes the ICVMC system directing a maintenance action to correct the problem state identified for the specific component. In one or more embodiments, the method 1300 includes associating the particular component with a location (block 1320). The method 1300 includes the ICVMC system associating a communication address for information technology (IT) personnel assigned to fix the problem state of the particular component at the specific location (block 1322). The method 1300 includes the ICVMC system transmitting maintenance information to IT personnel using the communication address to fix the problem state of the specific component at the location (block 1324). Then method 1300 ends.

In the above described flow charts of FIGS. 13A-13B, one or more of the methods may be embodied in an automated controller that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

One or more of the embodiments of the disclosure described can be implementable, at least in part, using a software-controlled programmable processing device, such as a microprocessor, digital signal processor or other processing device, data processing apparatus or system. Thus, it is appreciated that a computer program for configuring a programmable device, apparatus or system to implement the foregoing described methods is envisaged as an aspect of the present disclosure. The computer program may be embodied as source code or undergo compilation for implementation on a processing device, apparatus, or system. Suitably, the computer program is stored on a carrier device in machine or device readable form, for example in solid-state memory, magnetic memory such as disk or tape, optically or magneto-optically readable memory such as compact disk or digital versatile disk, flash memory, etc. The processing device, apparatus or system utilizes the program, or a part thereof, to configure the processing device, apparatus, or system for operation.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms “first”, “second”, etc. do not denote any order or importance, but rather the terms “first”, “second”, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. An information handling system (IHS) comprising:
a node having at least one functional component, wherein the node and the at least one functional component are capable of being in more than one functional state;
a network interface enabling communication with a network over which the node is connected;
a memory containing visual representations of the plurality of nodes with a plurality of different levels of visual representations, including a system level, node levels, sub-node levels, and component levels;
a display device that provides a graphical user interface (GUI) on which each of the different levels of visual representations can be presented;
at least one user input component capable of manipulating and/or interfacing with one or more items on the GUI; and
an interactive component-level visual monitoring and control (ICVMC) system comprising a processor in communication with the display device, the memory, and the network interface and ICVMC program modules executes on the processor and configures the ICVMC system to:
display on the display device the visual representation of one of the plurality of different levels of the IHS based on a current level identified/selected on the GUI;
receive, via the network interface, a current functional state of functional components at each component level that is being monitored;
determine an operating status of the at least one functional component from the current functional state received; and
display on the display device the operating status of the at least one functional component on the physical representation at each level of the plurality of different levels when the operating status includes a problem state from among a failed operating state, a malfunctioning state, and/or a check and/or repair (C/R) operating state; and
in response to receiving a user input selecting a specific component level among the one or more levels that is different from a current level being displayed, modify the GUI to display the physical representation of the specific component level and identifying any components having the problem state.

2. The IHS of claim 1, wherein the ICVMC system displays the status indication of the problem state on the display device by overlaying a color indication at a corresponding component location on the physical representation of each higher level displayed on the display device.

3. The IHS of claim 1, wherein:
the memory contains maintenance information corresponding to each of a plurality of different problem states of different components; and
the ICVMC system associates maintenance information with the problem state and directs a maintenance action to correct the problem state identified for the specific component.

4. The IHS of claim 3, wherein the maintenance information includes a location of the component and the ICVMC system transmits the maintenance information to IT personnel assigned to fix the problem state of the specific component.

5. The IHS of claim 4, wherein the maintenance information comprises a communication address of the IT personnel that is assigned to fix the problem states of the specific component at the location of the component.

6. The IHS of claim 3, wherein:
the ICVMC system contains executable code for correcting the problem state of the component from among a malfunction mitigating mode of operation for the component and an upgrade firmware for execution by the component; and
the ICVMC system directs the executable code to be installed on the component in response to the problem state.

7. The IHS of claim 1, wherein:
the node comprises a modular data center (MDC) that contains server systems and comprises one of an infrastructure environmental subsystem and an power infrastructure subsystem that includes the at least one functional component;
the physical representations comprise three-dimensional computer aided design (CAD) models; and
the ICVMC system displays the physical representations by rendering the CAD models at a user selected spatial orientation.

8. An interactive component-level visual monitoring and control (ICVMC) system of an information handling system (IHS), the ICVMC system comprising:
a network interface enabling communication with a network over which a node is connected, the node of the IHS having at least one functional component, wherein the node and the at least one functional component are capable of being in more than one functional state;
a memory containing visual representations of the plurality of nodes with a plurality of different levels of visual representations, including a system level, node levels, sub-node levels, and component levels;
a display device that provides a graphical user interface (GUI) on which each of the different levels of visual representations can be presented;
at least one user input component capable of manipulating and/or interfacing with one or more items on the (GUI); and
a controller comprising a processor in communication with the display device, the memory, and the network interface and ICVMC program modules executes on the processor and configures the ICVMC system to:
display on the display device the visual representation of one of the plurality of different levels of the IHS based on a current level identified/selected on the GUI;
receive, via the network interface, a current functional state of functional components at each component level that is being monitored;
determine an operating status of the at least one functional component from the current functional state received;
display on the display device the operating status of the at least one functional component on the physical representation at each level of the plurality of different levels when the operating status includes a problem state from among a failed operating state, a malfunctioning state, and/or a check and/or repair (C/R) operating state; and
in response to receiving a user input selecting a specific component level among the one or more levels that is different from a current level being displayed, modify the GUI to display the physical representation of the specific component level and identifying any components having the problem state.

9. The ICVMC system of claim 8, wherein the controller displays the status indication of the problem state on the display device by overlaying a color indication at a corresponding component location on the physical representation of each higher level displayed on the display device.

10. The ICVMC system of claim 8, wherein:
the memory contains maintenance information corresponding to each of a plurality of different problem states of different components; and
the controller associates maintenance information with the problem state and directs a maintenance action to correct the problem state identified for the specific component.

11. The ICVMC system of claim 10, wherein the maintenance information includes a location of the component and the ICVMC system transmits the maintenance information to IT personnel assigned to fix the problem state of the specific component.

12. The ICVMC system of claim 11, wherein the maintenance information comprises a communication address of the IT personnel that are assigned to fix the problem states of the specific component at the location of the component.

13. The ICVMC system of claim 10, wherein:
the ICVMC system contains executable code for correcting the problem state of the component from among a malfunction mitigating mode of operation for the component and an upgrade firmware for execution by the component; and
the controller directs the executable code to be installed on the component in response to the problem state.

14. The ICVMC system of claim 8, wherein:
the node comprises a modular data center (MDC) that contains server systems and comprises one of an infrastructure environmental subsystem and an power infrastructure subsystem that includes the at least one functional component;
the physical representations comprise three-dimensional computer aided design (CAD) models; and
the controller displays the physical representations by rendering the CAD models at a user selected spatial orientation.

15. A method of interactive component-level visual monitoring and controlling an information handling system (IHS), the method comprising:
displaying on a display device a visual representation of one of a plurality of different levels of the IHS based on a current level identified/selected on a graphical user interface (GUI);
receiving, via a network interface, a current functional state of functional components of the IHS at each component level that are being monitored;
determining an operating status of at least one functional component from the current functional state received;
displaying on the display device the operating status of the at least one functional component on the physical representation at each level of the plurality of different levels when the operating status includes a problem state from among a failed operating state, a malfunctioning state, and/or a check and/or repair (C/R) operating state; and
in response to receiving a user input selecting a specific component level among the one or more levels that is different from a current level being displayed, modifying the GUI to display the physical representation of the specific component level and identifying any components having the problem state.

16. The method of claim 15, wherein displaying the status indication of the problem state on the display device by overlaying a color indication at a corresponding component location on the physical representation of each higher level displayed on the display device.

17. The method of claim 15, further comprising:
associating maintenance information with the problem state of a particular component; and
directing a maintenance action to correct the problem state identified for the specific component.

18. The method of claim 17, further comprising:
associating the particular component with a location;
associating a communication address for information technology (IT) personnel assigned to fix the problem state of the particular component at the location; and
transmitting maintenance information to IT personnel using the communication address to fix the problem state of the specific component at the location.

19. The method of claim 17, further comprising:
associating executable code for correcting the problem state of the component from among a malfunction mitigating mode of operation for the component and an upgrade firmware for execution by the component; and
directing the executable code to be installed on the component in response to the problem state.

20. The method of claim 15, wherein:
the IHS comprises a modular data center (MDC) that contains server systems and comprises one of an infrastructure environmental subsystem and an power infrastructure subsystem that includes the at least one functional component;
the physical representations comprise three-dimensional computer aided design (CAD) models; and
modifying the GUI to display the physical representations comprises rendering the CAD models at a user selected spatial orientation.
